(19) United States
(12) Patent Application Publication
(10) Pub. No.: US 2005/0206103 A1
(43) Pub. Date: Sep. 22, 2005

(54) Apparatus for securing a shopping cart to a vehicle

(76) Inventors: Bernard Wayne Schmidt, New South Wales (AU); Gayle Maree Schmidt, New South Wales (AU)

Correspondence Address: MICHAEL MOLINS;MOLINS & CO., SUITE S, LEVEL 6, 139 MACQUARIE ST, SYDNEY NSW, 2000, AU

(21) Appl. No.: 10/893,239

(22) Filed: Jul. 19, 2004

(30) Foreign Application Priority Data
Mar. 10, 2004 (AU) 2004200403

(51) Int. Cl. B62D 39/00

(52) U.S. Cl. 280/33.992

(57) ABSTRACT

An apparatus for securing a wheeled device such as a shopping cart to a vehicle is disclosed. The apparatus comprises a hook end and a ring end. The hook end is inserted into the wire mesh of the shopping cart. The hook end also has a terminal hook that prevents accidental release of the shopping cart. The ring end has a shape allowing it to either be looped over a towing ball attached to the vehicle, or inserted into the door lock mechanism of the vehicle.

### BACKGROUND OF THE INVENTION

1. Field of the Invention

The present invention relates to an apparatus for securing a wheeled device, and more particularly, to an apparatus for securing a shopping cart to a vehicle.

2. Description of Related Art

Wheeled shopping carts are typically wire or plastic containers on castor wheels and provide transport for a customer's goods both within the store and between the store and the customer's vehicle. Many current shopping cart designs lack a braking mechanism, so the customer is left to control the cart both during transport of goods and while unloading the goods into the customer's vehicle. The parking areas of many establishments are often large and in some cases, sloped or subject to winds. Because the cart is wheeled, the cart may roll about the parking lot under the force of gravity or wind. This is a potential hazard to other people and vehicles in the proximate area. In some cases, an infant or child may be placed in seats or carriers in or on the shopping cart. In these cases, a runaway cart is a potential danger to the safety of the infant or child.

There are many cases where a single adult will be shopping with one or more children or infants. Without a brake, it is incumbent on the adult to control the shopping cart while goods and children or infants are moved from the shopping cart to the vehicle. Control is often by wedging an object under one or more wheel,
positioning the shopping cart so the force of gravity or wind presses the shopping cart against a stationary object such as a pillar, wall, or vehicle.

There are several problems with this attempted solution. First, the moving of infants, children, and large objects from the shopping cart to the vehicle in some cases requires the use of both hands by the adult. Second, the adult's attention is often diverted from the shopping cart to the vehicle during the movement of these objects, for example, to secure the child in a vehicle safety seat. Third, the placement of the shopping cart around the vehicle for convenient unloading suggests locating the cart near the vehicle's doors, that is, at the side or rear of the vehicle. These locations, however, may not coincide with the position necessary to prevent loss of control of the shopping cart. Finally, the process of moving objects from the shopping cart to the vehicle may jostle the cart potentially initiating loss of control of the cart.

A apparatus for securing a shopping cart which overcomes the above-stated problems is desired.

### SUMMARY AND OBJECTS OF THE PRESENT INVENTION

The present invention is an apparatus for securing a shopping cart or similar wheeled chart to a vehicle.

In one embodiment of the present invention, a rigid apparatus is used having a hook at one end and a ring, preferably ovate, at the other end. The hook end is shaped to allow it to be easily inserted into the wire mesh of the cart. The hook end preferably has a terminal bend which prevents the cart from being accidentally unhooked. The ring end is shaped to allow the ring to be slipped over a vehicle towing ball, or to be inserted into a vehicle door lock opening. The entire apparatus is constructed of a single length of wire having a single diameter and it is preferably coated to provide protection from deterioration and incidental damage to either the vehicle or cart.

It is therefore the object of the present invention to provide a lightweight, portable apparatus for securing a cart to a vehicle. It is another object to allow the cart to be attached to either a vehicle towing ball or an open vehicle door. It is yet another object to allow the apparatus to be quickly removed to release the cart when unloading is complete.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 illustrates a plan view of one embodiment of the apparatus of the present invention.

FIG. 2 illustrates a side view of the embodiment of FIG. 1.

FIG. 3 illustrates a detailed view of the embodiment of FIG. 1.

FIG. 4 illustrates a first attachment method of the present invention.

FIG. 5 illustrates a second attachment method of the present invention.

FIG. 6 illustrates a top perspective view of the second attachment method of the present invention.

### DESCRIPTION OF THE BEST MODE AND PREFERRED EMBODIMENT

The present invention is an apparatus for securing a shopping cart or similar wheeled cart to a vehicle. In the following description numerous specific details are set forth in order to provide a more thorough understanding of the present invention.

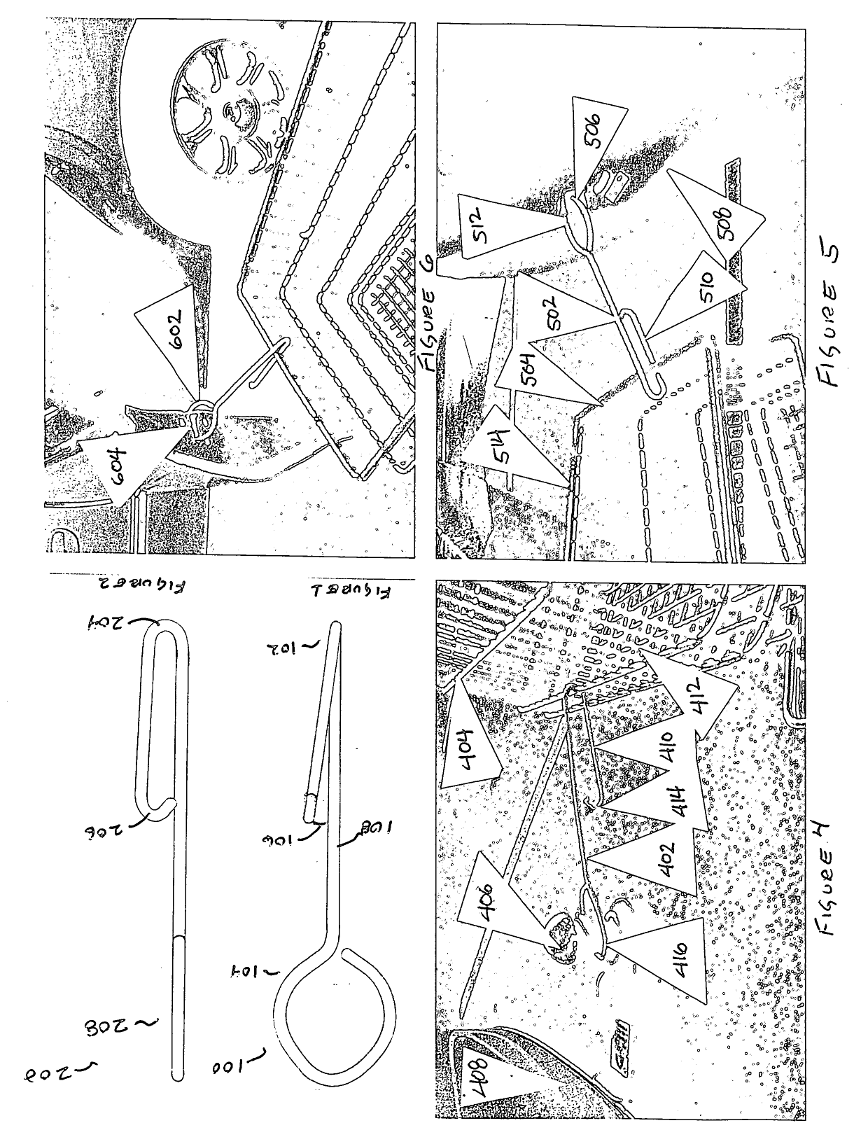

Referring first to FIG. 1-3, one embodiment of the present invention 100 comprises a rigid apparatus having a hook end 102 and a ring end 104. The apparatus is fabricated from a single length of metal approximately 500 mm long and 4 mm in diameter The return portion of the hook end 304 makes an angle 106 of approximately 10 degrees from with the shaft 108. FIG. 2 illustrates a 90-degree rotation of the embodiment of FIG. 1. The hook end comprises two bends. The first bend 204 has a diameter of approximately 15 mm, an angle of substantially 180 degrees, and a length of approximately one third of the overall length of the apparatus. A second bend or terminal hook 206, at the end of the return portion has a diameter of approximately 15 mm, an angle of approximately 150 degrees, and a length of approximately 10 mm. Thus the first bend and terminal hook have the same or about the same bend radius. As shown in FIG. 2, the terminal hook terminates approximately in the plane of the shaft 108, forming a secure catch. The ovate ring end 208 is in a plane substantially 90 degree from the plane of the second bend 206. In other words, as shown in FIG. 2, the hook end forms a closed loop in a plane perpendicular to the plane of the loop end The diameter of the wire is selected so that the apparatus provides a limited degree of movement at its extremities and when flexed, returns to its original position.

FIG. 3 illustrates the general measurements of the present invention 300. The shaft 302 (A minus B) is approximately 255 mm long. The return portion of the hook end 304 has a length D of approximately 110 mm; the second bend 306 has a length E of approximately 15 mm. The ovate ring 308 has a width C of approximately 70 mm and a height B of approximately 75 mm. There is an opening at the bottom of the ovate ring 312 of approximately 2 mm. The sides of the ring's top end 310 form an angle of approximately 45 degrees giving the ring an ovate shape. The width of the gap in the hook end G is about 15 mm as shown in FIG. 3(b).

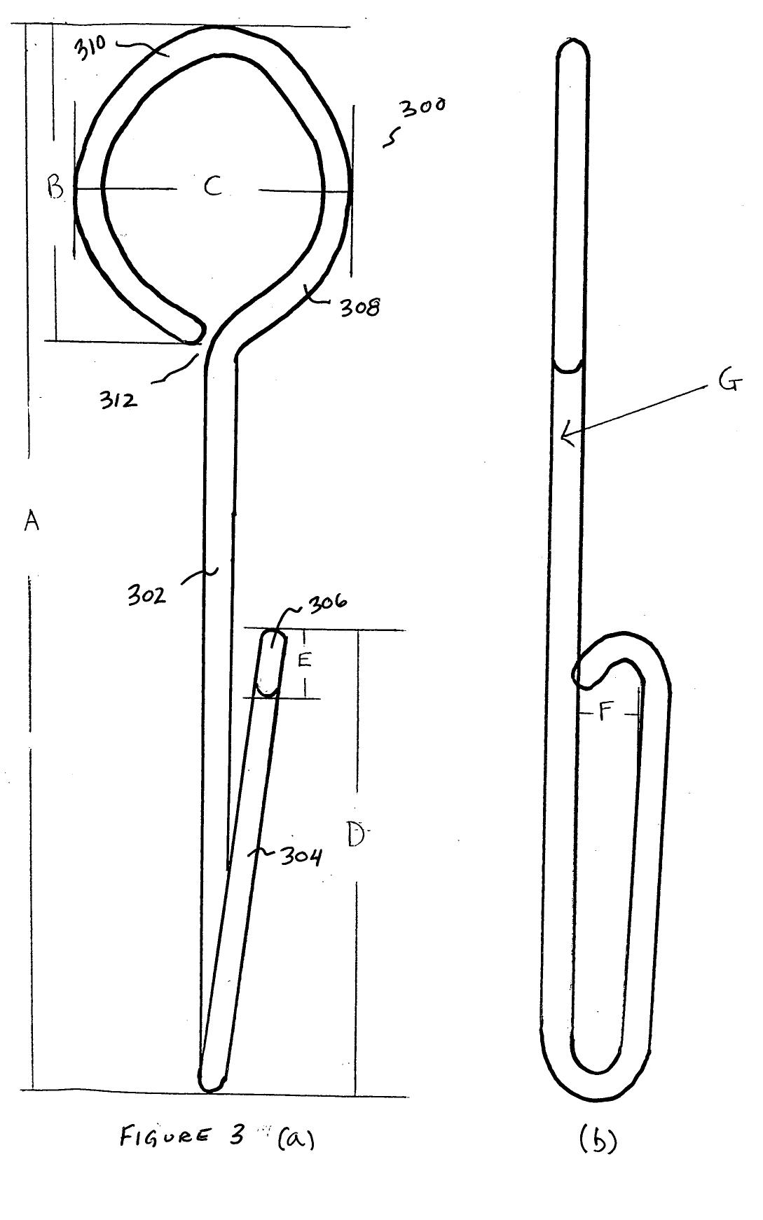

The design of the present invention allows for at least two methods of securing a shopping cart to a vehicle. A first is illustrated in FIG. 4. The apparatus 402 connects a wire shopping cart 404 to the tow ball 406 of a vehicle 408. The hook end of the apparatus 410 is inserted into the wire mesh of the cart 412. The minor hook or terminal hook 414 prevents the cart from being accidentally released during loading or unloading. The ovate ring end 416 is looped over the tow ball 406, securing the shopping cart in place. When loading or unloading is complete, the shopping cart is freed by unhooking the ovate ring 416 from the tow ball 406, and unhooking the wire mesh 412.

The second attachment method is shown in FIG. 5. The apparatus 502 connects a rail 504 of the shopping cart 514 to the door lock opening 506 of the vehicle door 508. The hook end of the apparatus 510 is inserted over the rail 504 and the top end of the ovate ring 512 is inserted into the door lock opening 506. The shape of the top end of the ovate ring, allows the apparatus to be large enough to be placed over a tow ball and yet be inserted into the lock mechanism, thus securing the shopping cart 514. To release the cart, the hook end 510 is unhooked from the top rail 504, and the door lock mechanism is activated to release the top end of the ovate ring 512. FIG. 6 shows a top view of the second method of attachment. The top end of the ovate ring 602 is shown engaged in the vehicle door lock opening 604.

When attached in its intended position, the apparatus can withstand a pulling tension between the ends of in excess of 30 kilograms without permanent deformation of the apparatus. The entire apparatus is coated for example with a polyethylene plastic cover having a thickness of approximately 1 mm.

It will be understood that the above described apparatus are merely illustrative of the application of the principles of the present invention and many other embodiments and modifications may be made without departing from the spirit and scope of the invention as defined in the claims.

1. An apparatus for attaching a cart to a vehicle, comprising:
a body having a ring end and a hook end, the ring end and hook end being connected by a shaft.

2. The apparatus of claim 1, wherein: the ring end is not circular, being longer than it is wide.

3. The apparatus of claim 2, wherein the ring end is ovate.

4. The apparatus of claim 1, wherein: the hook end comprises a first bend, a return portion and a terminal hook.

5. The apparatus of claim 4, wherein: the return portion is inclined with respect to the shaft.

6. The apparatus of claim 5, wherein: the return portion is inclined with respect to the shaft by about 10 degrees.

7. The apparatus of claim 4, wherein: the terminal hook terminates in the plane of the shaft.

8. The apparatus of claim 4, wherein: the first bend and terminal hook are formed with the same bend radius.

9. The apparatus of claim 4, wherein: the hook end forms a closed loop as seen in a plane perpendicular to the plane of the loop end.

10. The apparatus of claim 1, wherein: there is a gap between the terminus of the ring end and the shaft.

11. The apparatus of claim 1, wherein: the body is manually deformable.

12. The apparatus of claim 1, wherein: the body is made from wire.

13. The apparatus of claim 1, wherein: the body is made from a single wire.

14. The apparatus of claim 1, wherein: the body is made from wire of about 4 mm diameter.

15. The apparatus of claim 1, wherein: the body is made from wire that is coated.
